(19) United States
(12) Patent Application Publication
(10) Pub. No.: US 2023/0236384 A1
(43) Pub. Date: Jul. 27, 2023

(54) FOLLOW FOCUS WHEEL, CONTROL METHOD THEREOF, AND STORAGE MEDIUM

(71) Applicant: SZ DJI TECHNOLOGY CO., LTD., Shenzhen (CN)

(72) Inventors: Changjian HUANG, Shenzhen (CN); Huipeng YIN, Shenzhen (CN); Zhongyuan CAO, Shenzhen (CN)

(73) Assignee: SZ DJI TECHNOLOGY CO., LTD., Shenzhen (CN)

(21) Appl. No.: 18/128,257

(22) Filed: Mar. 30, 2023

Related U.S. Application Data
(63) Continuation of application No. PCT/CN2020/124030, filed on Oct. 27, 2020.

(51) Int. Cl. G02B 7/04; H02P 6/08

(52) U.S. Cl. CPC G02B 7/04; H02P 6/08

(57) ABSTRACT

A control method for a follow focus wheel, a follow focus wheel and a storage medium are provided. The control method may include: acquiring angular position information of a rotor of a motor of the follow focus wheel and electrical parameters of a coil of the motor; completing an output torque control and a target closed-loop control of the motor based upon the angular position information and the electrical parameters; and determining an operation sensation to be simulated, and controlling the motor to run based on a motor control strategy corresponding to the operation sensation to be simulated so as to provide corresponding operation sensation feedback.

### CROSS-REFERENCE TO RELATED APPLICATION

The present application is a continuation of International Application No. PCT/CN2020/124030, filed Oct. 27, 2020, the entire contents of which being incorporated herein by reference in its entirety.

### TECHNICAL FIELD

The present disclosure relates to the technical field of motor control, and particularly relates to a control method of a follow focus wheel, a follow focus wheel, and a storage medium.

### BACKGROUND

With the spread and development of short videos and video blogs, people have higher requirements for video shooting quality and creativity. They not only hope to shoot videos with stable, clear, and smooth image quality, but also hope that they may use a follow focus to capture the video, which gives people a refreshing sensory experience, with the follow focus technology. When using the follow focus technology, it is necessary to adjust the follow focus so that the follow focus may provide the user with corresponding operation sensation feedback, such as damping operation sensation feedback, etc. However, the existing operation sensation feedback is realized through physical components. For example, the damping operation sensation is achieved by using damping grease. This kind of operation sensation feedback realized by physical components may be easily affected by the environment, so it cannot provide accurate operation sensation feedback, thereby reducing the user experience.

### SUMMARY

The present disclosure provides a control method of a follow focus wheel, a follow focus wheel, and a storage medium. The follow focus wheel provided may provide an accurate operation sensation in different environments, thereby improving the user experience.

A first aspect of the present disclosure provides a control method of a follow focus wheel. The follow focus wheel may include an operating member, a motor, a driving circuit, and a main control circuit, the driving circuit may be electrically connected to the motor, the main control circuit may be electrically connected with the driving circuit, and the operating member may be mechanically coupled with a rotor of the motor and may drive the rotor of the motor to rotate together. The control method may include:

acquiring angular position information of the rotor of the motor of the follow focus wheel and electrical parameters of a coil of the motor;

completing an output torque control and a target closed-loop control of the motor based upon the angular position information and the electrical parameters, wherein the target closed-loop may include at least one of a position closed-loop or a velocity closed-loop; different target closed-loops are configured to simulate different types of operation sensations; and different types of operation sensations correspond to different motor control strategies; and

determining an operation sensation that needs to be simulated and controlling an operation of the motor based upon a motor control strategy corresponding to the operation sensation that needs to be simulated to provide corresponding operation sensation feedback.

A second aspect of the present disclosure provides a follow focus wheel, the follow focus wheel may include:

a motor including a rotor and a coil;

an operating member provided for a user to input a follow focus control signal, where the operating member is mechanically coupled with the rotor of the motor and may drive the rotor of the motor to rotate together;

a driving circuit connected to the motor and configured to drive the motor to rotate; and

a main control circuit connected with the driving circuit and configured to complete an output torque control and a target closed-loop control of the motor based upon angular position information of the rotor and electrical parameters of the coil of the motor, where the target closed loop may include at least one of a position closed loop or a velocity closed loop; different target closed loops are configured to simulate different types of operation sensations; and different types of operation sensations correspond to different motor control strategies,

wherein the main control circuit is further configured to: determine an operation sensation that needs to be simulated; and control an operation of the motor based upon a motor control strategy corresponding to the operation sensation that needs to be simulated to provide corresponding operation sensation feedback.

A third aspect of the present disclosure provides a follow focus wheel including a main control circuit. The main control circuit of the follow focus wheel may include a micro-controller unit, and the micro-controller unit may include a processor and a memory. The memory is configured to have a computer program stored thereon, and the processor is configured to execute the computer program and, when executing the computer program, configured to implement the steps of the control method of a follow focus wheel according to any one of the embodiments of the present disclosure.

A fourth aspect of the present disclosure provides a computer-readable storage medium, where the computer-readable storage medium stores a computer program, and when the computer program is executed by a processor to cause the processor to implement the steps of the control method of a follow focus wheel according to any one of the embodiments of the present disclosure.

Therefore, according to the control method of a follow focus wheel, the follow focus wheel, and the storage medium provided in the present disclosure, motor control strategies corresponding different operation sensations are run on the motor to provide different operation sensations, such as a damping operation sensation, a wave-wheel operation sensation, a rebound operation sensation, etc. In this way, different operation sensations are simulated through the motor and are not affected by environmental factors; thus, a more accurate operation sensation may be provided, thereby improving the user experience.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic structural diagram of a follow focus wheel according to some embodiments of the present disclosure.

FIG. 2 illustrates a schematic diagram of a circuit structure of a follow focus wheel according to some embodiments of the present disclosure.

FIG. 3 illustrates a schematic structural diagram of a motor part of a follow focus wheel according to some embodiments of the present disclosure.

FIG. 4 illustrates a schematic cross-sectional structure diagram of FIG. 3 along the A-A direction.

FIG. 5 illustrates a schematic diagram of the principle of closed-loop control of a motor according to some embodiments of the present disclosure.

FIG. 6 illustrates a schematic diagram of the principle of simulating a damping operation sensation according to some embodiments of the present disclosure.

FIG. 7 illustrates a schematic diagram of a corresponding relationship between an output amplitude and a motor velocity according to some embodiments of the present disclosure.

FIG. 8a and FIG. 8b illustrate schematic diagram of the principle of simulating a wave-wheel operation sensation according to some embodiments of the present disclosure.

FIG. 9a and FIG. 9b illustrate schematic diagram of the principle of simulating a rebound operation sensation according to some embodiments of the present disclosure.

FIG. 10 illustrates a schematic diagram of a corresponding relationship between an output amplitude and a motor position according to some embodiments of the present disclosure.

FIG. 11 illustrates a schematic diagram of a circuit structure of a follow focus wheel according to some embodiments of the present disclosure.

FIG. 12 illustrates a schematic diagram of a circuit structure of a follow focus wheel according to some embodiments of the present disclosure.

FIG. 13 illustrates a schematic diagram of a circuit structure of a follow focus wheel according to some embodiments of the present disclosure.

FIG. 14 illustrates a schematic diagram of a circuit structure of a follow focus wheel according to some embodiments of the present disclosure.

FIG. 15 illustrates a schematic flowchart of a control method of a follow focus wheel according to some embodiments of the present disclosure.

FIG. 16 illustrates is a schematic block diagram of a follow focus wheel according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, certain steps of the method may be performed in other orders or at the same time; some components/elements can also be disassembled, combined, or partially combined; therefore, the actual arrangement may be changed or modified according to actual conditions. In the case of no conflict, the components, elements, operations/steps, and other features disclosed in the embodiments may be combined with each other.

At present, with the spread and development of short videos and video blogs (e.g., Vlog), people have higher requirements for the quality and creativity of video shooting. They not only hope to shoot videos with stable, clear, and smooth quality, but also hope that a follow focus may be used to shoot a video with follow focus technology, so that the captured video will give people a refreshing sensory experience.

When the follow focus technology is used, it is necessary to adjust the follow focus so that the follow focus may provide a user with corresponding operation sensation feedback, such as damping operation sensation feedback, etc. However, the existing operation sensation feedback is realized through physical components. For example, the damping operation sensation is achieved by using damping grease, and the rebound operation sensation is realized through an elastic part (such as a spring). This kind of operation sensation feedback realized by physical components can be easily affected by the environment. For example, the fluidity of the damping grease may increase at high temperature, resulting in that the damping operation sensation feedback will be relatively reduced or even has no damping effect. But at low temperature, the fluidity of the damping grease will reduce, which increases the damping operation sensation feedback, or even causing a failure of rotation. Therefore, it is unable to provide accurate operation sensation feedback, reducing the user experience.

In addition, during the normal use of the follow focus, different users may have different operation sensations required. For example, when different users adjust the follow focus, due to different adjustment methods and strengths, there may be differences in the damping operation sensations required, But the use of damping grease may not provide different damping operation sensations for different users, such as damping operation sensations with different damping magnitudes.

Therefore, the present disclosure provides a control method of a follow focus wheel, a follow focus wheel, and a computer-readable storage medium, which may simulate an operation sensation of the follow focus wheel through a motor, thereby addressing the above problems and improving the user experience.

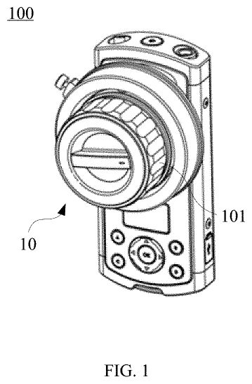

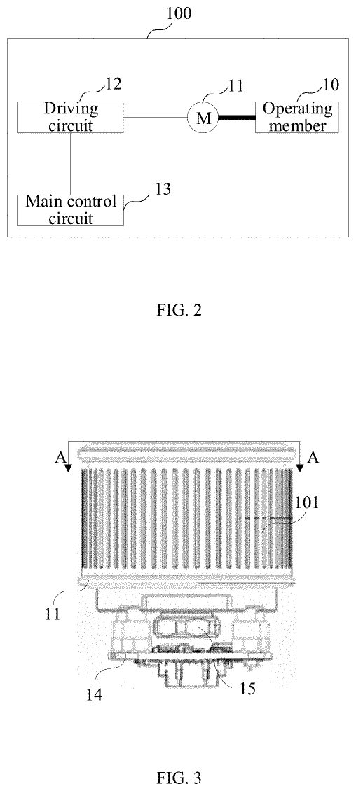

Please refer to FIGS. 1 and 2. FIG. 1 illustrates a schematic structural diagram of a follow focus wheel according to some embodiments of the present disclosure, and FIG. 2 illustrates a schematic diagram of a circuit structure of a follow focus wheel according to some embodiments of the present disclosure. As shown in FIG. 2, a follow focus wheel 100 may include an operating member or operator 10, a motor 11, a driving circuit 12, and a main control circuit 13, and the motor 11 may include a rotor and a coil.

In one embodiment, the operating member 10 is used for a user to operate and input a follow focus control signal. The operating member 10 may mechanically coupled with the rotor of the motor 11 and may drive the rotor of the motor 11 to rotate together; meanwhile the rotor of the motor 11 may also drive the operating member 10 to move during rotation. In this way, a corresponding operation sensation may be then simulated and fed back to the operating member 10.

The operation sensation may include a damping operation sensation, a wave-wheel operation sensation, or a rebound operation sensation and certainly may further include other types of operation sensations, which are not limited herein.

In some embodiments, as shown in FIG. 1, the operating member 10 may include, for example, a rubber ring 101, which is mechanically coupled with the rotor of the motor 11, such as through a shaft connection or through a gear connection, etc. When the user rotates the rubber ring 101, the rubber ring 101 may drive the rotor of the motor 11 to rotate together, and at the same time, the rotor of the motor 11 may also drive the rubber ring 101 to move during rotation, thereby simulating a damping operation sensation and feeding it back to the rubber ring 101.

In some embodiments, the operating member 10 may also include other types of members, such as a knob member or a rebound member. The knob member may feedback the wave-wheel operation sensation, and the rebound member may feedback the rebound operation sensation.

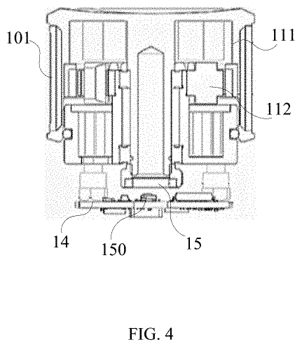

In some embodiments, as shown in FIGS. 3 and 4, a follow focus wheel 100 may include a circuit board 14, and the circuit board 14 may be provided with a driving circuit 12 and/or a main control circuit 13. Optionally, the driving circuit 12 may be provided on the circuit board 14, and the circuit board 14 may also be provided with a position sensor, such as a Hall sensor 150, which may cooperate with a magnetic ring 15 provided on a motor 11 to detect angular position information of a rotor of the motor 11.

The motor 11 may include a permanent magnet synchronous motor or a DC motor. Of course, it may also be other types of motors, which is not limited herein. As shown in FIG. 4, the motor 11 may include a rotor 111 and a coil 112.

The driving circuit 12 may be connected to the motor 11 and is configured to drive the rotor 111 of the motor 11 to rotate. In one embodiment, the driving circuit 12 may adopt a three-phase bridge inverter circuit to drive the rotor 111 of the motor 11 to rotate in commutation through a pulse width modulation (PWM) signal.

The main control circuit 13 may be connected to the drive circuit 12 and is configured to complete the output torque control and the target closed-loop control of the motor 11 based upon the angular position information of the rotor 111 of the motor 11 and electrical parameters of the coil 112 of the motor 11. The main control circuit 13 may include a processor and a memory.

The target closed-loop may include at least one of a position closed-loop or a velocity closed-loop. Different target closed-loops are used to simulate different types of operation sensations. Different types of operation sensations correspond to different motor control strategies. The electrical parameters of the coil of the motor 11 may include current and/or voltage.

Exemplarily, as shown in Table 1, different types of operation sensations may include a damping operation sensation, a wave-wheel operation sensation or a rebound operation sensation; the velocity closed-loop is used to simulate the damping operation sensation, and the position closed-loop is used to simulate the wave-wheel operation sensation and rebound operation sensation.

TABLE 1
Different motor control strategies corresponding
to different types of operation sensation

| | | |
|---|---|---|
| Type of operation sensation | Target closed-loop | Motor control |
| | | strategy |
| Damping operation sensation | Velocity closed-loop | Motor control |
| | | strategy I |
| Wave-wheel operation sensation | Position closed-loop | Motor control |
| | | strategy II |
| Rebound operation sensation | Position closed-loop | Motor control |
| | | strategy III |

In Table 1, the damping operation sensation runs on the velocity closed-loop, that is, the velocity closed-loop is used to realize the damping operation sensation feedback. The simulated wave-wheel operation sensation and rebound operation sensation run on the position closed-loop, that is, the position closed-loop is used to simulate the wave-wheel operation sensation and rebound operation sensation. Although the simulated wave-wheel operation sensation and rebound operation sensation both operate on the position closed-loop, the corresponding motor control strategies may be different.

In certain embodiments, Table 1 may be stored in the memory of the follow focus wheel, so that after determining the operation sensation that needs to be simulated, the table may be queried to determine the motor control strategy corresponding to the operation sensation that needs to be simulated.

After the output torque control of the motor 11 is completed, the main control circuit 13 may be further configured to: determine an operation sensation to be simulated and control an operation of the motor 11 based upon the motor control strategy corresponding to the operation sensation to be simulated, so as to provide corresponding operation sensation feedback.

For example, in one embodiments, it is determined that the operation sensation that needs to be simulated is a damping operation sensation, the motor 11 is controlled to run according to the motor control strategy I corresponding to the damping operation sensation, and the corresponding damping operation sensation feedback is provided; for example, in another embodiment, the operation sensation that needs to be simulated is determined to be a rebound operation sensation; then, the motor 11 is controlled to run according to the motor control strategy III corresponding to the rebound operation sensation, thereby providing corresponding rebound operation sensation feedback.

When the motor 11 is controlled to run according to the motor control strategy corresponding to the operation sensation that needs to be simulated, the motor 11 may be controlled to operate in a target closed-loop corresponding to the operation sensation that needs to be simulated, and a target parameter is determined and input into the target closed-loop for a closed-loop adjustment to provide corresponding operation sensation feedback.

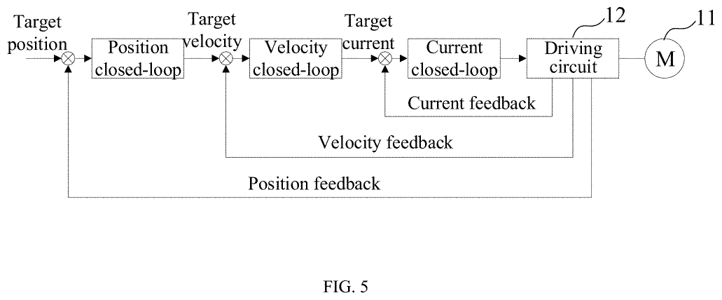

FIG. 5 illustrates a schematic diagram of the principle of closed-loop control of a motor according to some embodiments of the present disclosure. As shown in FIG. 5, for example, when it is determined that the operation sensation to be simulated is a damping operation sensation, the motor may be controlled to run on the velocity closed-loop, and a target velocity may be determined and the determined target velocity is input into the velocity closed-loop for a closed-loop adjustment, thereby providing damping operation sensation feedback; for another example, when it is determined that the operation sensation that needs to be simulated is a rebound operation sensation, the motor may be controlled to run on the position closed-loop, and a target position may be determined and the determined target position is input into the position closed-loop for a closed-loop adjustment, thereby providing rebound operation sensation feedback.

In some embodiments, when the main control circuit 13 completes the output torque control of the motor 11, it may be specifically configured to: realize a current closed-loop control of the motor 11 based upon the angular position information of the rotor 111 and the current of the coil 112, and then complete the output torque control of the motor 11. The current of the coil 112 of the motor 11 has a linear relationship with the output torque, that is, the greater the current of the motor is, the greater the output torque is, so that the strength of the same type of operation sensation may be easily adjusted to meet the needs of different users, thereby satisfying the differential needs of different users, which improves the user experience.

Determining the operation sensation that needs to be simulated may include determining the operation sensation that needs to be simulated based upon the detected operating member that is operated upon. For example, when it is detected that the user operates the rubber ring 101, it may be determined that the operation sensation that needs to be simulated is the damping operation sensation; For another example, when it is detected that the user operates the rebound member, it may be determined that the operation sensation that needs to be simulated is the rebound operation sensation. Of course, the operation sensation that needs to be simulated may also be determined according to the type of operation sensation selected by the user.

Therefore, the control method of the follow focus wheel provided by some embodiments of the present disclosure may simulate operation sensations by controlling the motor to operate on different target closed-loops based upon corresponding motor control strategies, and then provide different operation sensation feedbacks, such as providing damping operation sensation, wave-wheel operation sensation, or rebound operation sensation, etc. As such, different operation sensations are simulated by the motor, which is not affected by environmental factors, thereby improving the user experience.

The following will introduce the specific control strategies of the three operation sensations according to some embodiments of the present disclosure with reference to the accompanying drawings, that is, the motor control strategy corresponding to the damping operation sensation, the motor control strategy corresponding to the wave-wheel operation sensation, and the motor control strategy corresponding to the rebound operation sensation. It should be noted that the following description is merely for illustration of the present disclosure, not limitation of the present disclosure.

In some embodiments, when the operation sensation that needs to be simulated is a damping operation sensation, the corresponding motor control strategy I may include: controlling the motor 11 to run in the velocity closed-loop, setting a target velocity to zero and inputting the target velocity to the velocity closed-loop, so that the motor 11 may perform a velocity closed-loop adjustment based upon the target velocity to provide damping operation sensation feedback.

In certain embodiments, when the operation sensation to be simulated is a damping operation sensation, the operating member may be a rotating member. The rotating member may be mechanically coupled and connected to the rotor of the motor 11. When a user operates the rotating member, the main control circuit 13 controls the motor to run the motor control strategy I to simulate the damping operation sensation and feedback the damping operation sensation to the rotating member, so that the user may feel the damping sensation.

In one embodiment, the rotating member is a rubber ring 101, the rubber ring 101 is used to adjust the focal length of a lens. The rubber ring 101 and the rotor 111 of the motor 11 may drive the rotor 111 of the motor 11 to rotate together through gearing or the like. Of course, the rotating member may also be other members that realize the adjustment of the rotating function, which is not limited herein.

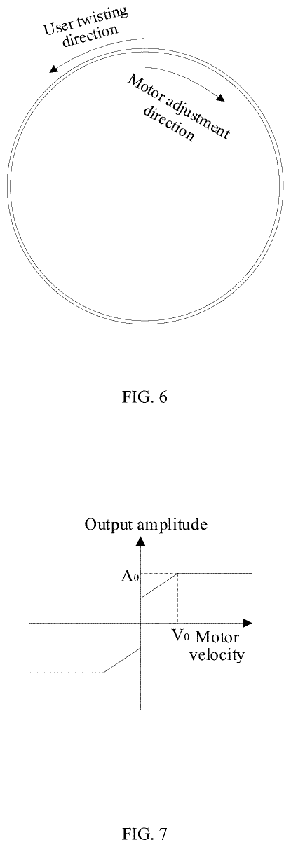

FIG. 6 illustrates a schematic diagram of the principle of simulating a damping operation sensation according to some embodiments of the present disclosure. As shown in FIG. 6, the damping operation sensation will be described by taking the rubber ring 101 as an example. When a user twists the rubber ring 101, for example, the user twists in the counterclockwise direction, since the rubber ring 101 is mechanically coupled with the rotor 111 of the motor 11, the rubber ring 101 will drive the rotor 111 of the motor 11 to rotate, for example, it also rotates counterclockwise. Meanwhile, the motor 11 is controlled to run in the velocity closed-loop, the target velocity is set to zero and input to the velocity closed-loop, and the motor 11 performs a velocity closed-loop adjustment according to the target velocity. Since the target velocity is zero, the rubber ring 101 rotates counterclockwise (forward rotation), the velocity closed-loop error is negative, and the motor will output a reverse torque based upon the forward rotation velocity, that is, the rotor 111 of the motor 11 will rotate in the opposite direction (i.e., clockwise direction) to prevent the user from twisting the rubber ring 101, thereby providing damping operation sensation feedback to the rubber ring 101. Similarly, when the rubber ring 101 rotates clockwise (reverse rotation), the velocity closed-loop error is positive, and the motor will output a forward torque based upon the reverse rotation velocity, that is, the rotor 111 of the motor 11 will rotate in the reverse direction (counterclockwise direction), which will prevent the user from twisting the rubber ring 101, so that the user may feel the damping sensation. Since the damping operation sensation is simulated by the motor, it will not be affected by environmental factors such as temperature, thereby improving the user's experience.

In some embodiments, in order to make the simulated damping operation sensation more realistic, so as to improve the user's experience, when the damping operation sensation feedback is provided, the rotation velocity of the motor has a positive correlation with the output torque of the motor, and the output torque is not greater than a preset threshold.

In one embodiment, the faster the twisting velocity of the user is, the faster the rotation velocity of the motor is. Since the rotation velocity of the motor is positively correlated with the output torque of the motor, the faster the rotation velocity of the motor is, the greater the output torque of the motor will be. As a result, the greater the corresponding resistance will become, the stronger the damping operation sensation will be felt, so the more realistic damping operation sensation will be. However, for example, as shown in FIG. 7, the damping sensation cannot be increased all the time during twisting, so the output torque is limited to not greater than the preset threshold A₀, that is, when the motor velocity reaches a certain value V₀, the output torque will no longer increase with the increase of motor velocity.

In some embodiments, when the operation sensation that needs to be simulated is a wave-wheel operation sensation, the corresponding motor control strategy II may include: controlling the motor 11 to operate in a position closed-loop; acquiring the current position of the rotor 111 of the motor 11; determining a target gear position based upon the current position; and inputting the determined target gear position as a target position to the position closed-loop, so that the motor 11 may perform a position closed-loop adjustment based upon the target position, thereby providing wave-wheel operation sensation feedback.

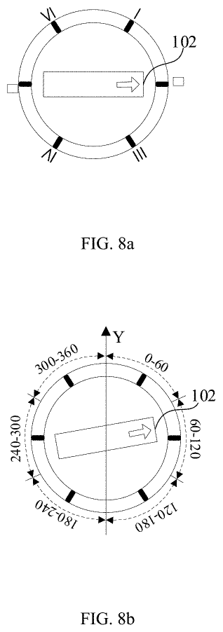

FIG. 8a and FIG. 8b illustrate schematic diagram of the principle of simulating a wave-wheel operation sensation according to some embodiments of the present disclosure. For example, as shown in FIG. 8a, when the simulated operation sensation is a wave-wheel operation sensation, the operation member may be a knob member, and the knob member may be connected to the rotor 111 of the motor 11, for example, through a shaft, so as to drive the rotor 111 of the motor 11 to rotate together when the knob member rotates. When a user operates the knob member, the main control circuit 13 controls the motor 11 to simulate the wave-wheel operation sensation and feeds back the wave-wheel operation sensation to the knob member.

In certain embodiments, as shown in FIG. 8a, the knob member is a knob 102, and the knob 102 corresponds to different gear functions, for example six gear functions, namely, gear I, gear II, gear III, gear IV, gear V and gear VI. Different gears have different functions, so that the user may select the corresponding gear function by rotating the knob 102. When the user rotates the knob 102, it is necessary to simulate the wave-wheel operation sensation and feedback the simulated wave-wheel operation sensation to the user, so that the user may feel the rotation to a specific gear.

Because the target gear position, such as a selected gear position, as the target position is input into the position closed-loop, the motor 11 may perform a position closed-loop adjustment based upon the target position, so that the user may have a hand sensation of a cogging torque in the process of rotating the knob 102, i.e., the wave-wheel operation sensation.

The acquiring the current position of the rotor 111 of the motor 11 may include acquiring a current angular position of the rotor 111 of the motor 11 and determining the target gear position based upon the current angular position. The target gear position may be a gear position determined from a plurality of gear positions. As shown in FIG. 8a and FIG. 8b, the gear position corresponding to gear I is 30 degrees, the gear position corresponding to gear II is 90 degrees, the gear position corresponding to gear III is 150 degrees, the gear position corresponding to gear IV is 210 degrees, the gear position corresponding to gear V is 270 degrees, and the gear position corresponding to gear VI is 330 degrees.

In some embodiments, the determining the target gear position based upon the current position may include, from the plurality of gear positions, determining the gear position closest to the current position as the target gear position, where different gear positions correspond to different gears.

For example, the current position is 25 degrees, the gear position closest to the current position is gear I, and the gear position corresponding to gear I is 30 degrees, so it may be determined that the gear position of gear I is the target gear position.

In some embodiments, the determining the target gear position based upon the current position may include determining a preset position range to which the current position belongs and determining the gear position corresponding to the determined preset position range as the target gear position. Different preset position ranges correspond to different gear positions, as shown in Table 2 and FIG. 8b.

TABLE 2
Different preset position ranges correspond to different gear positions

| | | | | | | |
|---|---|---|---|---|---|---|
| Preset position | [0, 60) | [60, 120) | [120, 180) | [180, 240) | [240, 300) | [300, 360) |
| range (°) | | | | | | |
| Gear position (°) | 30 | 90 | 150 | 210 | 270 | 330 |

In Table 2, the corresponding gear position of the preset position range [0, 60) is 30 degrees, the corresponding gear position of the preset position range [60, 120) is 90 degrees, the corresponding gear position of the preset position range [120, 180) is 150 degrees, the corresponding gear position of the preset position range [180, 240) is 210 degrees, the corresponding gear position of the preset position range [240, 300) is 270 degrees, and the corresponding gear position of the preset position range [300, 360) is 330 degrees.

Thus, the current position of the motor may be acquired, and the preset position range in which the current position is located may be queried to determine the corresponding gear position as the target gear position.

For example, as shown in FIG. 8b, when it is determined that the current position of the motor is within the preset position range [60, 120), it may be determined that the gear position 90 degrees is the target gear position.

It should be noted that in some practical applications, the wave-wheel operation sensation may be applied to, for example, select different menu options through the knob member, and different menu options correspond to different functions, such as selecting different shooting modes, or selecting different photo brightness levels.

In some embodiments, when the operation sensation that needs to be simulated is a rebound operation sensation, the corresponding motor control strategy III may include: controlling the motor 11 to run in the position closed-loop; and inputting a zero position as a target position into the position closed-loop, so that the motor 11 performs a position closed-loop adjustment based upon the target position, thereby providing the rebound operation sensation feedback. The zero position may be the middle position of a parameter adjustment range.

For the rebound operation sensation, the operation member may include a rebound member, which may be connected to the rotor 111 of the motor 11 through a mechanical coupling. The mechanical coupling connection may be a connection structure for realizing swing, such as a crank connecting rod structure. When the rebound member is operated, the main control circuit may control the motor to run to simulate a rebound operation sensation and feed back to the rebound member.

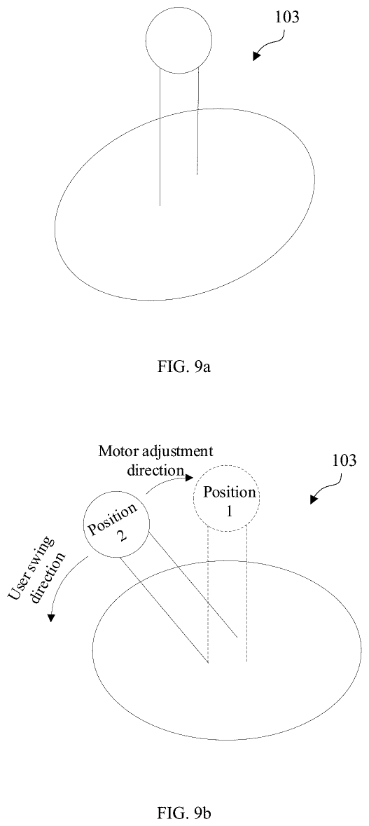

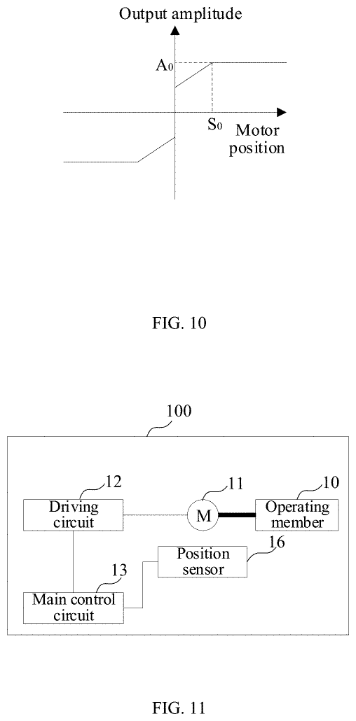

FIG. 9a and FIG. 9b illustrate schematic diagram of the principle of simulating a rebound operation sensation according to some embodiments of the present disclosure. As shown in FIG. 9a, the rebound member may be a joystick 103. The rebound operation sensation of the existing joystick is mostly realized by a spring. As the service time increases, the elastic force of the spring will gradually weaken, which in turn affects the rebound operation sensation.

The parameter adjustment range may be the range that the joystick may reach in a certain direction, such as positions that the joystick 103 may reach left and right in the horizontal direction, and a range that the joystick 103 may reach up and down in the vertical direction.

Exemplarily, as shown in FIG. 9b, when it is determined that the operation sensation to be simulated is a rebound operation sensation, for example, when a user swings the joystick 103 from position 1 to position 2, the motor 11 is controlled to run in the position closed-loop, and the zero position (i.e., the middle position of the joystick 103) is input to the position closed-loop as the target position, so that the motor 11 may perform a position closed loop adjustment based upon the target position, that is, the joystick 103 is swung from position 1 to position 2 according to the swing direction of the user, and when the motor 11 performs the closed-loop adjustment based upon the target position, a torque in the opposite direction (i.e., the motor adjustment direction shown in FIG. 9b) will be output to drive the joystick 103 to return to position 1, thereby realizing the rebound operation sensation feedback.

In some embodiments, in order to make the simulated rebound operation sensation more realistic and improve the user experience, when providing the rebound operation sensation feedback, it is defined that the angular position information is positively correlated with the output torque of the motor, and the output torque is not greater than a preset threshold. That is, the greater the deviation of the angular position information from the middle position is, the greater the corresponding output torque of the motor is, and the stronger the corresponding rebound operation sensation is; as a result, a more realistic rebound operation sensation is simulated. However, the rebound operation sensation cannot always be enhanced with the increase of the angular position information (i.e., the deviation from the middle position increases), so the output torque may be limited to not be greater than the preset threshold. That is, when the angular position information of the rotor of the motor reaches the angle S₀, the output torque is A₀, and the output torque is not increasing.

In some embodiments of the present disclosure, the angular position information of the rotor 111 of the motor 11 may be obtained by utilizing a position sensor or by software calculation without using a position sensor.

For example, in certain embodiments, the follow focus wheel 100 may further include a position sensor 16, and the position sensor 16 is used to detect the angular position information of the rotor of the motor 11 and send the angular position information to the main control circuit 13. The position sensor 16 may include at least one of a magnetic ring Hall sensor, a photoelectric encoder, or a magnetic encoder.

In some embodiments, a magnetic ring position Hall sensor may be used. For example, as shown in FIG. 4, a magnetic ring 15 is installed on the motor 11, and a Hall sensor 150 is installed on the circuit board 14. The angular position information of the rotor of the motor 11 may be detected through the Hall sensor 150 and the magnetic ring 15. The Hall sensor may be a single-axis Hall sensor or a three-axis Hall sensor, and the number of Hall sensors is not limited and may be one or more.

In some embodiments, for example, the angular position information may be obtained by software calculation. The main control circuit may specifically acquire the current and voltage of the motor during operation and calculate the angular position information of the rotor of the motor based upon the current and voltage.

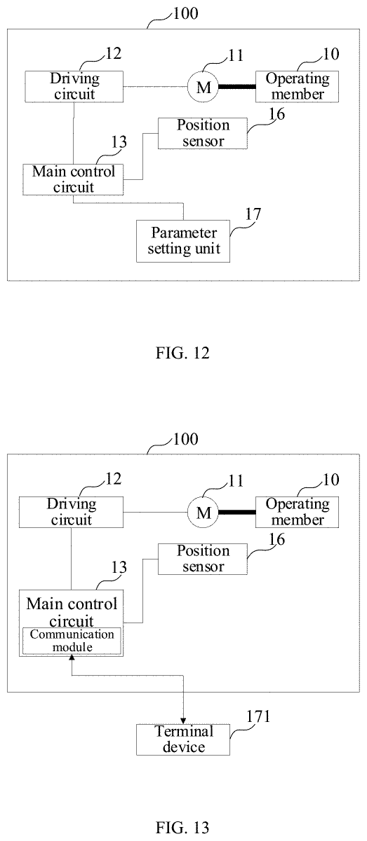

In some embodiments, in order to facilitate the user's operation and quick determination of the operation sensation that needs to be simulated and to improve the user's experience, as shown in FIG. 12, the follow focus wheel 100 may further include a parameter setting unit 17, and the parameter setting unit 17 is configured to communicatively connect to the main control circuit 13, so as to obtain a parameter set by a user and send the parameter to the main control circuit 13. The parameter may include at least one type of operation sensation.

After receiving the parameter set by the user, the main control circuit 13 may determine the operation sensation that needs to be simulated according to the type of operation sensation included in the parameter.

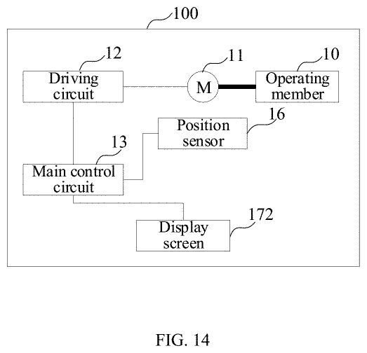

In some embodiments, as shown in FIG. 13 and FIG. 14, the parameter setting unit 17 may include a terminal device 171 and a display screen 172. The display screen 172 is connected to the main control circuit 13 for communication connection, or the main control circuit 13 may include a wireless communication module and establish a wireless communication connection with the terminal device 171 through the wireless communication module. Thus, the parameter may be set through the terminal device 171 or the display screen 172, for example, the type of the operation sensation to be simulated or the resistance level may be set.

The resistance level is used to adjust the strength of the operation sensation and may be linearly related to the current of the coil 112 of the motor 11, i.e., the larger the resistance is set, the greater the current of the coil 112 of the motor 11 is, so the stronger the damping operation sensation is. Thus, users may conveniently set the operation sensation that suits them, which may easily meet the different requirements of different users for the operation sensation. By adjusting the resistance level, the strength of the operation sensation may be adjusted, which may satisfy the requirements that different users may want different strengths of operation sensation when adjusting the follow focus wheel.

The wireless communication module may be, for example, a Bluetooth module, a Wi-Fi module, a Zigbee module, etc. The terminal device may be, for example, a mobile phone, a tablet computer, a notebook computer, a desktop computer, or a wearable electronic device. The display screen may be a touch display, including an LED display, an LCD display, an OLED display, or other types of displays.

The parameter set by the user through the terminal device 171 or the display screen 172 may include different types of operation sensations, such as a damping operation sensation, a wave-wheel operation sensation or a rebound operation sensation. The main control circuit 13 is configured to obtain the operation sensation selected by the user among different types of operation sensations displayed on the terminal device 171 or the display screen 172, so further to determine the operation sensation that needs to be simulated.

It should be noted that, in addition to the terminal device 171 or the display screen 172, the parameter setting unit 17 may also be a physical key. For example, multiple different keys are provided to represent different types of operation sensations. When the user presses different keys, different types of operation sensations may be selected; Alternatively, one key may be provided, which may include a plurality of different operation modes representing different types of operation sensations individually or in combination.

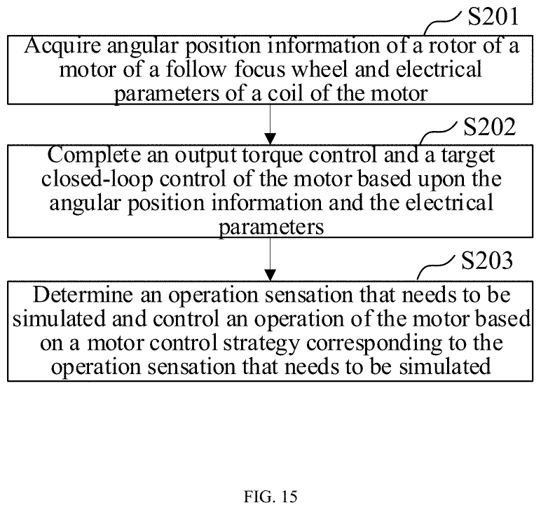

Please refer to FIG. 15, which illustrates a schematic flowchart of a control method of a follow focus wheel according to some embodiments of the present disclosure. The control method may be applied to the main control circuit of the follow focus wheel described in any one of the embodiments of the present disclosure, so as to provide more accurate operation sensation feedback, thereby improving the user experience.

Different motor control strategies corresponding to different types of operation sensations may be pre-stored in the follow focus wheel, for example, the motor control strategies corresponding to the three types of operation sensations in Table 1 may be stored in the follow focus wheel, which facilitates to determine the corresponding motor control strategy when determining the operating sensation that needs to be simulated.

As shown in FIG. 15, the control method of a follow focus wheel may include steps S201 to S203.

S201. Acquire angular position information of a rotor of a motor of a follow focus wheel and electrical parameters of a coil of the motor.

S202. Complete an output torque control and a target closed-loop control of the motor based upon the angular position information and the electrical parameters.

S103. Determine an operation sensation that needs to be simulated and control an operation of the motor based on a motor control strategy corresponding to the operation sensation that needs to be simulated, so as to provide corresponding operation sensation feedback.

For example, the closed-loop control of current of the motor may be realized based upon the angular position information of the rotor of the motor and the current of the coil of the motor, and then the output torque control of the motor may be completed, where the current of the coil of the motor has a linear relationship with the output torque.

The target closed-loop may include at least one of a position closed-loop or a velocity closed-loop, different target closed-loops are used to simulate different types of operation sensations, and different types of operation sensations correspond to different motor control strategies.

The controlling the operation of the motor based on the motor control strategy corresponding to the operation sensation that needs to be simulated may include controlling the motor to run in a target closed-loop corresponding to the operation sensation that needs to be simulated, determining a target parameter, and inputting the target parameter to the target closed-loop for a closed-loop adjustment to provide corresponding operation sensation feedback.

For example, as shown in Table 1, the different types of operation sensations may include a damping operation sensation, a wave-wheel operation sensation, or a rebound operation sensation. Among them, the velocity closed-loop is used to simulate the damping operation sensation, and the position closed-loop is used to simulate the wave-wheel operation sensation and rebound operation sensation. The damping operation sensation corresponds to the motor control strategy I, the wave-wheel operation sensation corresponds to the motor control strategy IL, and the rebound operation sensation corresponds to the motor control strategy III.

In some embodiments, the motor control strategy I may include: controlling the motor to run in a velocity closed-loop; setting a target velocity to zero and inputting the target velocity to the velocity closed-loop, so that the motor may perform a velocity closed loop adjustment based upon the target velocity, thereby providing damping operation sensation feedback.

In some embodiments, when controlling the motor to run the motor control strategy I and providing damping operation sensation feedback, it may be defined that the rotation velocity of the motor has a positive correlation with the output torque of the motor, and the output torque is not greater than a preset threshold, so as to produce a more realistic operation sensation.

In some embodiments, the motor control strategy II may include: controlling the motor to run in a position closed-loop; acquiring a current position of the rotor of the motor, and determining a target gear position based upon the current position; and inputting the determined target gear position as a target position into the position closed-loop, so that the motor may perform a position closed-loop adjustment based upon the target position, thereby providing wave-wheel operation sensation feedback.

The determining the target gear position based upon the current position may include: determining a preset position range to which the current position belongs and utilizing a gear position corresponding to the determined preset position range as the target gear position, where different preset position ranges correspond to different gear positions; or determining the gear position closest to the current position as the target gear position from a plurality of gear positions, where different gear positions correspond to different gears.

In some embodiments, the motor control strategy III may include: controlling the motor to run in a position closed-loop; inputting a zero position as a target position to the position closed-loop, so that the motor performs a position closed-loop adjustment based upon the target position, thereby providing rebound operation sensation feedback, where the zero position is the middle position of a parameter adjustment range.

When the motor is controlled to run the motor control strategy III and provide rebound operation sensation feedback, it may be defined that the angular position information has a positive correlation with the output torque of the motor, and the output torque is not greater than a preset threshold, so as to produce a more realistic operation sensation.

In the embodiments of the present disclosure, the electrical parameters of the coil of the motor may include current of the coil of the motor and/or voltage of the coil of the motor.

In some embodiments, to acquire the angular position information of the rotor of the motor, the angular position information of the rotor of the motor may be acquired through a position sensor, where the position sensor may include at least one of a magnetic ring Hall sensor, a photoelectric encoder, or a magnetic encoder.

In some embodiments, to acquire the angular position information of the rotor of the motor, the current and voltage of the motor when the motor is operating may be acquired, and the angular position information of the rotor of the motor is determined based upon the current and voltage.

In some embodiments, in order to improve the user experience, a parameter set by the user may be obtained through a parameter setting unit of the follow focus wheel, where the parameter may include at least one type of operation sensation. An exemplary parameter setting unit may include a display screen or a terminal device; the display screen may be connected to the main control circuit to achieve communication connection; the main control circuit may include a wireless communication module, and the main control circuit may communicate with the terminal device through the wireless communication module to establish a wireless communication connection.

In some embodiments, different types of operation sensations, such as damping operation sensation, wave-wheel operation sensation, and rebound operation sensation, may be displayed on the parameter setting unit for the user to select. The parameter selected by the user in the parameter setting unit may be obtained to determine the operation sensation that needs to be simulated.

In some embodiments, the parameter set by the user may further include a resistance level, which is used to adjust the strength of an operation sensation, where the resistance level may be linearly related to the current of the coil of the motor, the larger the resistance is set, the larger the current is, and the stronger the corresponding operation sensation is. Therefore, it is possible to achieve the adjustment of the strength of the same type of operation sensation, thereby meeting the needs of different users and improving the user experience.

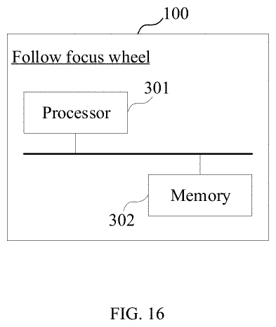

Please refer to FIG. 16, which illustrates is a schematic block diagram of a follow focus wheel according to some embodiments of the present disclosure. As shown in FIG. 16, the follow focus wheel may further include one or more processors 301 and memory 302.

The processor 301 may be, for example, a micro-controller unit (MCU), a central processing unit (CPU), a digital signal processor (DSP), or the like. The memory 212 may be a Flash chip, a read-only memory (ROM), a magnetic disk, an optical disk, a U disk, a removable hard disk, etc. The memory 302 is configured to have a computer program stored thereon and the processor 301 is configured to execute the computer program and, when executing the computer program, configured to implement the control method of the follow focus wheel disclosed above.

It should be noted that the implementation process and technical effects of the follow focus wheel are similar to those in the method embodiments disclosed above. For parts that are not described in detail in the instance device, please refer to the relevant description of the method embodiments described above, which will not be repeated herein for conciseness.

The present disclosure also provides a computer-readable storage medium having stored a computer program thereon. The computer program may include program instructions, which may be executed by a processor to cause the processor to implement the steps of any of the control methods of the follow focus wheel provided in the foregoing method embodiments.

The computer-readable storage medium may be an internal storage unit of the follow focus wheel described in any of the foregoing embodiments, such as a hard disk or a memory of the follow focus wheel. The computer-readable storage medium may also be an external storage device of the follow focus wheel, such as a plug-in hard disk, a smart media card (SMC), and a secure digital (SD) card, a flash card, etc., equipped on the follow focus wheel.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer program, program instructions and/or program codes described in this disclosure can be downloaded to an appropriate computing or processing device from a computer readable storage medium or to an external computer or external storage device via a global network (i.e., the Internet), a local area network, a wide area network and/or a wireless network.

The network may include copper transmission wires, optical communication fibers, wireless transmission, routers, firewalls, switches, gateway computers and/or edge servers. A network adapter card or network interface in each computing or processing device may receive computer readable program instructions from the network and forward the computer program/program instructions/program codes for storage in a computer readable storage medium within the computing or processing device.

The computer program, program instructions and/or program codes for carrying out operations of the present disclosure may include machine language instructions and/or microcode, which may be compiled or interpreted from source code written in any combination of one or more programming languages, including assembly language, Basic, Fortran, Java, Python, R, C, C++, C#, or similar programming languages. the computer program/program instructions/program codes may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer program/program instructions/program codes by using information from the computer program/program instructions/program codes to configure or customize the electronic circuitry, in order to perform aspects of the present disclosure.

The computer program, program instructions and/or program codes that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. The computer program/program instructions/program codes may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer program, program instructions and/or program codes may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The program may be a collection of machine readable instructions and/or data that is stored in non-volatile storage medium and is used to create, manage, and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

Each part of the present disclosure may be implemented by hardware, software, firmware, or a combination thereof. In the above exemplary embodiments, multiple steps or methods may be implemented by hardware or software stored in a memory and executed by a suitable instruction execution system.

It is understandable that the disclosed device and method may be implemented in other manners. For example, the device embodiments described above are merely schematic, the division of the units and modules is merely a logical function division, and in actual implementation, there may be another division manner, for example, multiple units, modules, or components may be combined or integrated into another system, or some features may be ignored or not performed. In addition, the displayed or discussed mutual coupling or direct coupling or communication connection can be indirect coupling or communication connection through some interfaces, devices, or units, and can be in electrical, mechanical, or other forms.

The units and modules described as separate parts may or may not be physically separate, and parts displayed as units/modules may or may not be physical units, that is, may be located in one place, or may be distributed on a plurality of network units. Some or all of the units/modules can be selected according to actual requirements to achieve the purpose of the scheme of the embodiment. In addition, functional units in the embodiments of the present disclosure may be integrated into one processing unit, or each of the units may exist alone physically, or two or more units may be integrated into one unit. The integrated unit may be realized in the form of hardware and may also be realized in the form of a hardware plus software functional unit.

Unless otherwise defined, all technical and scientific terms used herein have the same meaning as commonly understood by those skilled in the technical field of the present disclosure. The terms used herein are only for the purpose of describing specific embodiments and are not intended to limit of the disclosure. As used in this disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items. The term “based upon” used herein may be understood as not necessarily intended to convey an exclusive set of factors and may, instead, allow for existence of additional factors not necessarily expressly described, depending at least in part on context. Terms such as “connected” or “linked” are not limited to physical or mechanical connections, and may include electrical connections, whether direct or indirect. Phrases such as “a plurality of,” “multiple,” or “several” mean two and more.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A control method for controlling a follow focus wheel, the control method comprising:
determining an operation sensation to be simulated;
determining a motor control strategy for a motor of the follow focus wheel corresponding to the operation sensation; and
controlling parameters of the motor based upon the motor control strategy corresponding to the operation sensation to be simulated so as to provide corresponding operation sensation feedback.

2. The control method of claim 1, wherein the motor control strategy comprises a determination of a target closed-loop of the motor, the target closed-loop comprising at least one of a position closed-loop or a velocity closed-loop.

3. The control method of claim 2, wherein the velocity closed loop is configured to simulate a damping operation sensation, and the position closed loop is configured to simulate a wave-wheel operation sensation or a rebound operation sensation.

4. The control method of claim 2, wherein the parameters of the motor comprises at least one of a current, a voltage, or angular position of the motor.

5. The control method of claim 2, wherein, upon determining that the operation sensation to be simulated is the damping operation sensation, the controlling the operation of the motor based upon the motor control strategy corresponding to the operation sensation to be simulated so as to provide the corresponding operation sensation feedback comprises:
controlling the motor to run in the velocity closed-loop; and
setting a target velocity to zero and inputting the target velocity to the velocity closed-loop, so that the motor performs a velocity closed loop adjustment based upon the target velocity to provide damping operation sensation feedback.

6. The control method of claim 5, wherein, when providing the damping operation sensation feedback, a rotation velocity of the motor has a positive correlation with an output torque of the motor, and the output torque is not greater than a preset threshold.

7. The control method of claim 2, wherein, upon determining that the operation sensation to be simulated is the wave-wheel operation sensation, the controlling the operation of the motor based upon the motor control strategy corresponding to the operation sensation to be simulated so as to provide corresponding operation sensation feedback comprises:
controlling the motor to run in the position closed-loop;
acquiring a current position of the rotor of the motor, and determining a target gear position based upon the current position; and
inputting the determined target gear position as a target position into the position closed-loop, so that the motor performs a position closed-loop adjustment based upon the target position to provide wave-wheel operation sensation feedback.

8. The control method of claim 7, wherein the determining the target gear position based upon the current position comprises:
determining a preset position range to which the current position belongs, wherein different preset position ranges correspond to different gear positions; and
utilizing a gear position corresponding to the determined preset position range as the target gear position.

9. The control method of claim 7, wherein the determining the target gear position based upon the current position comprises:
determining a gear position closest to the current position as the target gear position from a plurality of gear positions, where different gear positions correspond to different gears.

10. The control method of claim 2, wherein, upon determining that the operation sensation to be simulated is the rebound operation sensation, the controlling the operation of the motor based upon the motor control strategy corresponding to the operation sensation to be simulated so as to provide corresponding operation sensation feedback comprises:
controlling the motor to run in the position closed-loop;
inputting a zero position as a target position to the position closed-loop, so that the motor performs a position closed-loop adjustment based upon the target position to provide rebound operation sensation feedback,
wherein the zero position is a middle position of a parameter adjustment range.

11. The control method of claim 10, wherein, when providing the rebound operation sensation feedback, the angular position information has a positive correlation with an output torque of the motor, and the output torque is not greater than a preset threshold.

12. The control method of claim 1, wherein the follow focus wheel further comprises a position sensor, and the acquiring the angular position information of the rotor of the motor comprises acquiring the angular position information of the rotor of the motor through the position sensor.

13. The control method of claim 12, wherein the position sensor comprises at least one of a magnetic ring Hall sensor, a photoelectric encoder, or a magnetic encoder.

14. The control method of claim 1, wherein the acquiring the angular position information of the rotor of the motor comprises:
acquiring a current and a voltage of the motor when the motor is operating; and
determining the angular position information of the rotor of the motor based upon the current and the voltage of the motor.

15. The control method of claim 1, wherein the follow focus wheel further comprises a parameter setting interface, and the parameter setting interface is configured to communicatively connect with a main control circuit of the follow focus wheel; and
wherein the control method further comprises acquiring a parameter set by a user through the parameter setting interface, wherein the parameter comprises at least one type of operation sensation.

16. The control method of claim 15, wherein the parameter setting interface comprises a display screen or a terminal device; the display screen is communicatively connected to the main control circuit; and the main control circuit comprises a wireless communication module and communicates with the terminal device through the wireless communication module through a wireless communication connection.

17. The control method of claim 15, further comprising:
displaying different types of operation sensations on the parameter setting interface for the user to select; and
acquiring the operation sensation selected by the user as the operation sensation to be simulated on the parameter setting interface.

18. The control method of claim 15, wherein the parameter further comprises a resistance level, where the resistance level is configured to adjust a strength of the operation sensation.

19. The control method of claim 3, further comprising:
performing a current closed-loop control of the motor based upon the angular position information of the rotor and the current of the coil of the motor so as to complete the output torque control of the motor,
wherein the current of the coil of the motor has a linear relationship with an output torque of the motor.
